(19) United States
(12) Patent Application Publication
(10) Pub. No.: US 2026/0344573 A1
(43) Pub. Date: Nov. 5, 2026

(54) AGRICULTURAL SYSTEM FOR MONITORING AND CONTROLLING AN IMPLEMENT

(71) Applicant: AGCO International GmbH, Neuhausen Am Rheinfall (CH)

(72) Inventor: Martin Peter Christiansen, Randers (DK)

(21) Appl. No.: 19/487,146

(22) PCT Filed: Apr. 26, 2024
(86) PCT No.: PCT/IB2024/054076

§ 371 Date: Nov. 24, 2025

(30) Foreign Application Priority Data
May 25, 2023 (GB) 2307852.0

(51) Int. Cl. A01D 78/10; A01B 59/00; A01B 73/04

(52) U.S. Cl. CPC A01D 78/1007; A01B 59/002; A01B 73/044; A01D 78/1085

(57) ABSTRACT

An agricultural system (1) includes an implement (6), a sensor unit (4) and a control unit (40). The implement (6) has a chassis member (9), a first tool (10) relatively moveable in respect of the chassis member (9) and a first marker (34) assigned to the first tool (10). The sensor unit (4 ) is configured to capture the first marker (34). The control unit (40) is configured to receive sensor information from the sensor unit (4) and to determine a relative position or a relative movement of the first marker (34) in respect of the chassis member (9). A method for monitoring and controlling the implement (6) can be carried out by the control unit (40).

### FIELD

The present disclosure relates generally to an agricultural system for monitoring and controlling an implement that may be used to perform an agricultural operation in an agricultural field.

### BACKGROUND

Implements as ploughs, seeders, sprayers, mowers, tedders, rakes, etc. are used for the cultivation of agricultural fields. Such implements comprise one or more tools that are adapted to perform a treatment of the agricultural field the implement is provided for. For example, seeder comprises a seeding unit to place seeds into the soil, a sprayer comprises a nozzle to apply a fertilizer or a pesticide on crop and a rake comprises a rake rotor to form windrows. The tools are moveable relative to a frame of the implement to adjust the position or the speed of the tool for the field operation.

### BRIEF SUMMARY

The quality of a field operation may depend on movement parameters of the tools of an implement used to treat an agricultural field. Tools that are not operating at adequate position or speed may produce a worse result than tools operating at an adequate position or speed. Thus, it is an objective to monitor and to control movement parameters such as the position or speed of a tool of an implement for an optimal field operation.

According to an aspect of the invention there is provided an agricultural system comprising an implement, a sensor unit and a control unit. The implement has a chassis member, a first tool relatively moveable in respect of the chassis member and a first marker assigned to the first tool. The sensor unit is configured to capture the first marker. The agricultural system also comprises a control unit configured to receive sensor information from the sensor unit and to determine a relative position or a relative movement of the first marker in respect of the chassis member.

The implement may be of any type having at least one tool to perform a field operation intended to be executed according to the type of the implement. The first tool is relatively moveable in respect of the chassis member to adjust at least one movement parameter of the first tool as for example position or speed of the first tool in respect of the chassis member of the implement. Hence, a movement parameter of the first tool is adaptable if the first tool is not working at an adequate position or speed. For example, the implement may be a rake having one or more rake rotors as relatively moveable tools.

The first marker is assigned to the first tool so that the at least one movement parameter of the first tool is detectable by the sensor unit capturing the first marker. It is sufficient that the first marker can be captured by the sensor unit. The first tool itself may be out of a sensing range of the sensor unit. The sensor unit may comprise one or more sensors of any type or any combination of different types as for example a 3D camera, LIDAR, radar, etc. The control unit may determine the at least one movement parameter of the first tool based on the detected at least one movement parameter of the first marker captured by the sensor unit and may determine if the first tool is operating adequately. In case that the first tool operates with an inadequate movement parameter the control unit may adjust the movement parameter, e. g. the position or the speed of the first tool.

The sensor unit may comprise a perception sensor. The perception sensor may be of the type of a 2D-camera, a stereo camera, a time-of-flight (ToF) camera or a lidar, for example. A ToF camera could provide depth information and improve accuracy of detection and pose estimation of the first marker. A lidar could provide 3D point cloud data for detection and improved pose estimation of the first marker. In case of a camera, the perception sensor may capture 2D or 3D images, gray-scale images, color images in any color space as for example in red-green-blue (RGB) color space, or multispectral images. The perception sensor may capture the environment around the agricultural system and may be oriented towards the implement so that the first marker can be captured for all positions or orientations the first marker can take. The sensor unit could comprise multi-camera setup to provide multiple views of agricultural system and to improve the accuracy of detection and pose estimation of the first marker as well as to increase robustness to occlusions and shadows.

The perception sensor may comprise an optical lens such as a standard pin-hole lens or a fish-eye lens, for example. The fish-eye lens may be of the type of a F-theta lens, a F-tan lens, a tailored distortion lens or a fovea lens, for example. The perception sensor may comprise a color filter to better detect specific wavelengths, for example the wavelengths of the light reflected from the first marker. The filter may pass selected spectral bands such as ultraviolet, infrared or other bands.

The perception sensor may also comprise a detector and processing circuitry. The optical lens may collect and direct light from a field of view of the perception sensor through a filter to the detector and serve to focus and/or magnify images. The detector may be a digital image sensor that converts electromagnetic energy to an electric signal and employs image sensing technology such as charge-coupled device (CCD) technology and/or complementary metal oxide semiconductor (CMOS) technology. The processing circuitry may include a circuitry for amplifying and processing the electric signal generated by the detector to generate image data, which is passed to the one or more computing devices such as the control unit.

The sensor unit may optionally comprise an external light source such as natural ambient light or an artificial light source such as a light mounted on the agricultural system. The light source may be configured and used specifically for capturing images with the perception sensor. The light source may be a flashing lamp or a light emitting diode (LED) to improve image quality in low-light conditions such as during nighttime operations. The lamp could be an internal light source of the agricultural system that has been modified for this purpose.

The control unit may be configured to determine both a relative position and a relative movement of the first marker in respect of the chassis member.

I. e., the same first marker may be used to determine more than one movement parameter instead of the implementation of separate markers for each movement parameter.

The agricultural system may comprise a vehicle with a coupling for connecting the implement with the vehicle.

The vehicle may be an agricultural vehicle such as a tractor or a combine. The implement may be connected to the coupling of the vehicle. The coupling may be located at a rear side of the vehicle so that the implement may be pulled by the vehicle through the agricultural field for a field operation. The coupling may be for example a 3-point hitch. Alternatively, the coupling may be located at a front side of the vehicle so that the implement may be pushed by the vehicle through the agricultural field.

The implement may comprise a basic marker assigned to the chassis member. The sensor unit may be configured to capture the basic marker. The control unit may be configured to determine a relative position of the basic marker in respect of the vehicle.

The basic marker may be of the same type as the first marker and may be fixed to the chassis member of the implement. Since the sensor unit may be configured to capture both the basic marker and the first marker an additional sensor unit is not required. Based on the relative position of the basic marker in respect of the vehicle the control unit may also determine a relative position of the first marker in respect of the vehicle.

The first marker may be relatively moveable in respect of the basic marker. So, the first marker may not only move synchronously with the basic marker but may also move independently from the basic marker.

The first marker may be fixed to the first tool. Thus, a movement of the first tool corresponds directly with a movement of the first marker. The first marker may be designed as a retrofit kit so that implements without any markers can be equipped with a first marker later on. The same applies to the basic marker.

The first marker may be an optical code.

The optical code may be designed as a bar code, a QR code, an ArUco code, an AprilTag or any other pattern that may be recognizable by a camera. The pattern may be arranged in a circular shape to define a circular pattern. The pattern may comprise small and large dots arranged in a specific sequence that represents a unique ID for identifying the first tool to which the first marker is attached. The pattern may be printed onto relevant surfaces of the first tool. The optical code may be a black and white code or a colored code. Alternatively, the first marker may be of another type as for example an emitter of electromagnetic waves. The electromagnetic waves may be part of the visible light spectrum. For example, the first marker may comprise a sequence LEDs in the visible spectrum to define a circular pattern. To ensure detection even in low-visibility conditions, such as dusty or nighttime environments, the wavelength of the LEDs may ideally be in the 625-660 nm range, but could also be higher, such as 700 nm or 800 nm. Optionally, the first marker could be designed as an element emitting a magnetic field or as a passive element such as a RFID-chip.

The sensor unit is adapted to the first marker accordingly to detect any movement parameter of the first marker. The sensor unit may capture images of the implement or the first marker and analyze the pattern of the first marker to determine angular position and rate of the first tool to which the first marker is attached. For example, first marker is used to calculate the relative pose of the first tool with respect to the sensor unit. The high-order factors such as angular acceleration and jerk can be estimated by using a Kalman filter that takes input from both the angle and angular rate data. The sensor unit may additionally provide key feature tracking to improve accuracy and robustness. Key feature tracking enables the detection of important features of the image, such as edges, corners, ridges, and blobs, and the tracking how they align in the next image in the sequence. Optionally, the sensor unit may execute monocular depth estimation algorithms to estimate depth information from a single camera image, improving the accuracy of marker detection and pose estimation.

The first tool may be rotatable about a rotation axis.

The rotation axis may be oriented in any direction. For example, the rotation axis may be parallel to a horizontal plane for folding or unfolding the first tool. The first tool may be brought into contact with the agricultural field in the unfolded position and may be brought out of contact in the unfolded position. Alternatively, the rotation axis may be oriented vertically. The first tool may treat the agricultural field when it rotates about the rotation axis. For example, a rake rotor of a rake may form a windrow when it rotates about its rotation axis. The control unit may control the rotational movement of the first tool. For example, the control unit may start or stop the rotational movement, may move the first tool to a predefined position, or may control the speed or acceleration of the first tool. The rotational movement of the first tool may be driven by a rotational movement of the power take-off. Since the first marker is attached to the first tool, the first marker moves according to the first tool. Same applies to the other markers.

Alternatively, the rotational movement of the power take-off may be transformed into an axial movement of the first tool. I. e., the first tool may be moved along an axis oriented in any direction. For example, the axis may be parallel or perpendicular to a horizontal plane. The first tool may be moved back and forth along the axis, for example to perform a linear, reciprocating movement. Cams may be used to convert the rotational movement of the power take-off to the linear, reciprocating movement. Since the first marker is attached to the first tool, the first marker moves according to the first tool. Same applies to the other markers.

The control unit may be configured to determine a rotational speed of the first marker.

Based on the rotational speed of the first marker the control unit may determine the rotational speed of the first tool. I. e., the control unit and the sensor unit do not need to be configured to detect and determine a movement of the first tool as such. Instead, the movement of the first tool may be determined indirectly by means of the first marker. Analogously, the control unit may be configured to determine an axial speed of the first marker.

The control unit may be configured to determine a deviation of the rotational speed of the first marker from a target speed value.

For example, the target speed value may be a maximum allowed speed or a recommended speed for an optimal field operation. The control unit may determine whether the rotational speed of the first marker is above or below the target speed value and may adjust the rotational speed of the first marker to meet the target speed value. The control unit may send a warning message if the rotational speed of the first marker exceeds the target speed value.

The vehicle may comprise a power take-off for driving the first tool. The control unit may be configured to determine a rotational movement parameter of the power take-off, to determine a movement parameter of the first marker and to check whether the movement parameter of the first marker and the rotational parameter of the power take-off are consistent.

The implement may be connected to the power take-off of the vehicle to transfer a drive torque form the power take-off to the first tool. Depending on whether an implement is connected to a coupling at a front or a rear side of the vehicle, the first tool may be driven by a power take-off located at a front side of the vehicle or by a separate power take-off located at a rear side of the vehicle. In both cases, a movement parameter of the first tool may be controlled by the rotational movement of the power take-off. For example, the first tool may speed up accordingly if the rotational movement of the power take-off accelerates. The control unit may determine any movement parameters of the power take-off as well as of the first marker such as position, speed or acceleration. The control unit may compare the movement parameters of the power take-off and the first marker and check if the movement parameters of the power take-off and the first marker are consistent. The movement parameters of the power take-off and the first marker may be inconsistent if the first marker moves faster or slower than expected in respect of the rotational speed of the power take-off, for example if the power take-off stands still and the first marker moves or vice versa. In case of a detected inconsistency the control unit may execute a safety function such as sending a warning message to an operator of the agricultural system. Analogously, the control unit may be configured to determine a deviation of the axial speed of the first marker from a target speed value.

The control unit may be configured to determine a deviation of a quality indicator of the operation of the first tool from a target quality indicator and to adjust a movement parameter of the first marker for reducing the deviation of the quality indicator from the target quality indicator.

The quality indicator may be determined based on the work result of the first tool. For example, the shape of a windrow formed by rake rotor as a first tool of a rake may be a quality indicator for the rake rotor. The shape of the windrow may be poor if the rake rotor rotates too fast or too slow. The work result may by captured by the sensor unit or by another sensor. The control unit may receive the sensor information of the work result and may determine a quality indicator based on the work result. The control unit may compare the quality indicator with a predefined target quality indicator for determining a deviation between the quality indicator and the target quality indicator. The control unit may adjust the movement parameter of the first marker according to the deviation, for example to speed up the first marker if the first marker moves too slowly. The control unit may also adjust the position of the first marker to reduce the deviation. The movement parameter of the first tool may be adjusted according to the adjustment of the movement parameter of the first marker.

The control unit may be configured to determine a status of a field area ahead of the first tool and a status of a field area behind the first tool and to determine the quality indicator of the operation of the first tool based on a comparison of the status of the field area ahead of the first tool and the status of the field area behind of the first tool.

The status of the field area ahead and behind the first tool may be detected by the sensor unit or any other sensor. The status of the field area ahead of the first tool may represent the agricultural field before the field operation whereas the status of the field area behind of the first tool may represent the agricultural field after the field operation by the first tool. The control unit may receive the status of the field area ahead and behind the first tool and may compare both. Based on the comparison the control unit may evaluate the work result of the first tool and determine a quality indicator of the operation of the first tool.

The coupling may be adjustable for adjusting the position of the first marker in respect of the vehicle. The control unit may be configured to determine a target position for the first marker and to adjust the coupling for moving the first marker to the target position.

The first tool may provide work results of poor quality if the first tool is out of an adequate position. The control unit may determine a target position for the first marker representing an adequate position for the first tool for providing better or optimal work results. The control unit may control the coupling of the vehicle to move the first marker to the target position for improving the position of the first tool. The coupling may be moved in a horizontal or in a vertical direction wherein the implement connected with the coupling moves accordingly with the coupling. Since the first tool is connected with the implement the first tool moves together with the implement. The target position may alternatively be a predefined position as for example a transport position for keeping the implement out of engagement with the ground or a working position to bring the implement in engagement with the agricultural field.

The control unit may be configured to determine a target position for the first marker and to move the first tool relatively to the chassis member for moving the first marker to the target position.

Instead of adjusting the coupling and moving the complete implement the first tool may be moved relatively to the implement only so that the chassis member of the implement may keep its position in respect of the coupling of the vehicle. The first tool may rotate about its rotation axis for moving the first marker to the target position. The control unit may trigger an actuator connected between the chassis member and the first tool to adjust the position of the first marker. The target position may representing an adequate position for the first tool for providing better or optimal work results as mentioned before.

The first tool may be moveably attached to a first tool holder. The first tool holder may be moveably attached to the chassis member of the implement for adjusting a height of the first marker between a lifting position and a working position for bringing the first tool in or out of an operational position.

The first tool may be relatively movable in respect of the first tool holder. Then, the first tool may be moveable in two different degrees of freedom in respect of the chassis member of the implement, for example rotatable about a vertical axis and rotatable about a horizontal axis. The control unit may be configured to control any movement of the first tool in both degrees of freedom independently from each other based on the same first marker. So, the control unit may be configured to determine a relative position or a relative movement of the first marker in respect of the first tool holder and to determine a relative position or a relative movement of the first marker in respect of the chassis member.

The implement may comprise mechanical stops or stoppers to limit the range of motion of the first tool. This would allow for a more precise measurement of angles and movement as the first tool would not be able to move past the stopper.

The first tool holder may be adjusted by an actuator arranged between the chassis member and the first tool holder. The first marker may be moved with the first tool holder accordingly. For example, the height of the first marker may be adjusted by a vertical movement of the first tool holder. The first tool holder may be controlled by the control unit to move the first marker from a lifting position at which the first tool is out of an operational position to a working position at which the first tool may be brought in an operational position. In the operational position the first tool is operable to treat the agricultural field. In the operational position, the first tool may be in or out of engagement with the agricultural field dependent of the type of the first tool. For example, the first tool may be in engagement with the agricultural field in the operational position in case of a rake rotor and may be out engagement in case of a spraying unit. The lifting position and the working position may be defined each as a target position. Optionally, the first marker may be moved to any other position between the lifting and the working position.

The first tool holder may be pivotable about a hinge joint.

Then, the height of the first marker may be adjusted by a rotational movement of the first tool holder about a horizontal axis for example instead of a vertical movement. The hinge joint may enable a folding of the first tool holder for providing a compact arrangement of the implement. The first tool holder may be folded to move the first tool out of the operational position or unfolded to move the first tool in to the operational position.

The control unit may be configured to move the first marker out of the working position if the rotational speed of the first marker is below the target speed value.

The deviation of the rotational speed of the first marker from the target speed value may be an indication of an erroneous operation of the first tool. For example, the first tool may be blocked by an obstacle such as a stone. To avoid a damage of the first tool the control unit may move the first marker out of the working position to bring the first tool out of the operational position.

The implement may comprise a second tool relatively moveable in respect of the chassis member and a second marker assigned to the second tool. The sensor unit may be configured to capture the second marker. The control unit may be configured to determine a relative position and/or a relative movement of the second marker in respect of the chassis member.

The second tool may be of the same type as the first tool. The second marker may also be of the same type as the first marker. So, all technical features of the first tool may apply analogously to the second tool as well as all technical features of the first marker may apply analogously to the second marker. For example, the second marker may be fixed to second tool.

The second marker may be relatively moveable in respect of the basic marker and relatively moveable in respect of the first marker.

For example, the second marker may be moved with a different speed than the first marker or to a different position than the first marker or at a different time point than the first marker. Nevertheless, the second marker may be operated synchronically with the first marker.

Another aspect includes a method for monitoring and controlling an implement of an agricultural system comprising the steps of receiving sensor information of a first marker being relatively movable in respect of a chassis member of the implement, determining a relative speed of the first marker in respect of the chassis member, determining a target speed value for the first marker, determining a deviation of the relative speed of the first marker from the target speed value and reducing the deviation of the relative speed of the first marker from the target speed value by adjusting the relative speed of the first marker.

Depending on the degree of freedom the first marker may be moveable in an axial direction or in a rotational direction. Thus, the relative speed of the first marker in respect of the chassis member may be an axial speed or a rotational speed. The speed of the first marker may be adjusted by adjusting the speed of the first tool, by adjusting the speed of the tool holder or both. Hence, speed of the first tool can be adjusted for an optimal field operation by detecting a marker instead of the first tool as such.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates an agricultural system comprising a vehicle connected with an implement.

FIG. 2 illustrates the agricultural system of FIG. 1 with the implement in an operational position.

FIG. 3 illustrates the implement out of the operational position.

FIG. 4A illustrates a tool of the implement with a first type of a marker.

FIG. 4B illustrates a tool of the implement with a second type of a marker.

FIG. 4C illustrates a tool of the implement with a third type of a marker.

FIG. 5 illustrates a simplified view of a control unit of the agricultural system.

FIG. 6 illustrates a simplified view of a perception sensor.

FIG. 7 illustrates a flow chart for a method executable by the control unit.

### DETAILED DESCRIPTION

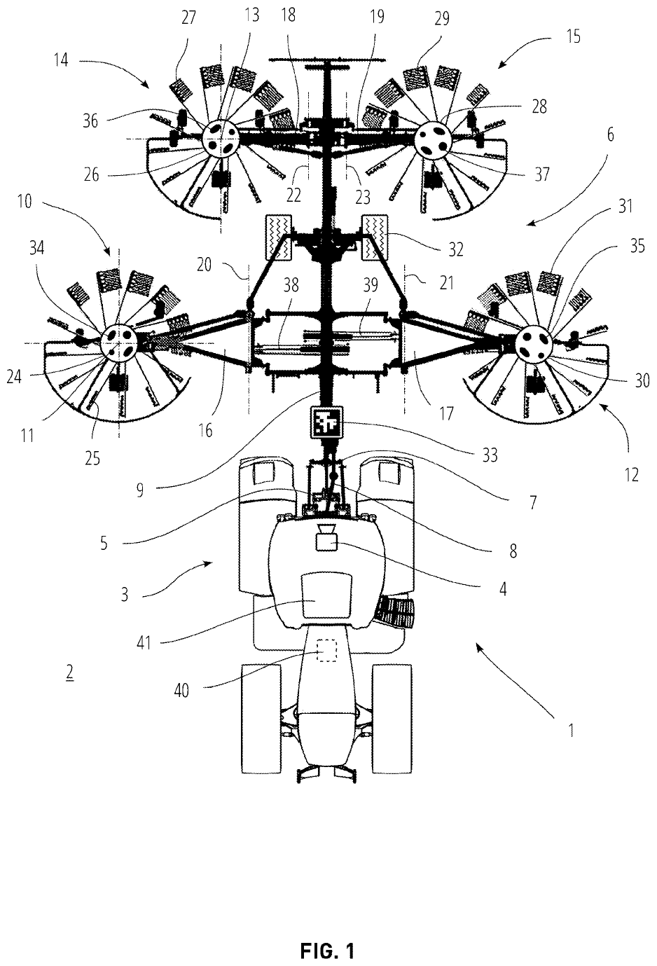

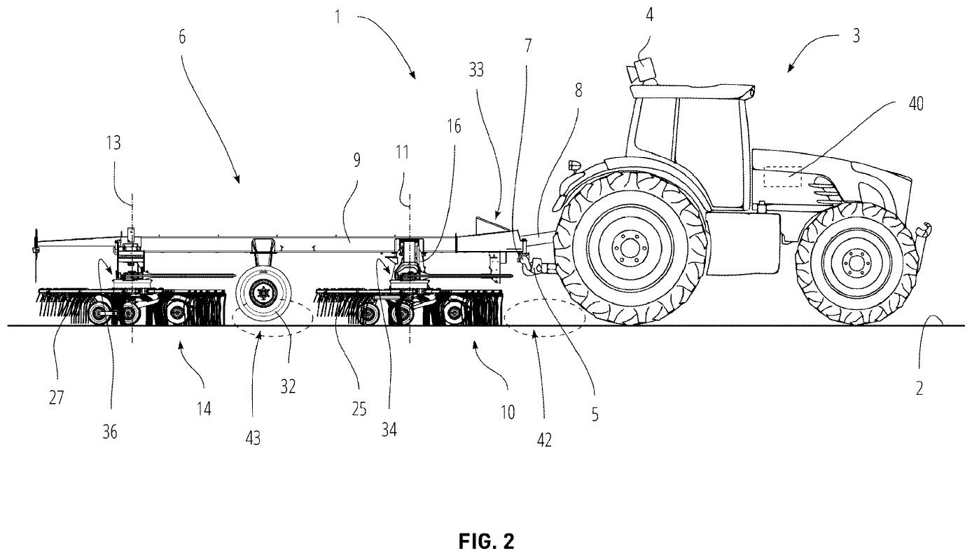

FIG. 1 and FIG. 2 show an agricultural system 1 on an agricultural field 2. The agricultural system 1 comprises a vehicle 3, an implement 6, a sensor unit 4 and a control unit 40. The vehicle 3 is an agricultural vehicle such as a tractor, for example. But the vehicle 3 can be of any other type such as a truck or a pickup.

The control unit 40 is integrated in the vehicle 3. The sensor unit 4 is attached to a top of a cabin of the vehicle 3. In addition, the vehicle 3 comprises an absolute positioning system 41 such as an inertial measurement unit (IMU) or a global navigation satellite system (GNSS) receiver (see FIG. 1). The IMU may provide additional orientation information for improving the accuracy of the global pose estimates.

Alternatively, the control unit 40, the absolute positioning system 41 and the sensor unit 4 may be attached to other parts of the agricultural system 1. For example, the control unit 40 and the absolute positioning system 41 could be integrated in the implement 6.

The vehicle 3 comprises a coupling 5 for connecting a mounting linkage 7 of the implement 6 to pull the implement 6 over the agricultural field 2 when the vehicle 3 moves. The coupling 5 may be designed as a 3-point hitch. The coupling 5 is adjustable to raise or lower the connected mounting linkage 7 of the implement. Optionally, the coupling 5 can be adjusted in a horizontal direction to move the mounting linkage 7 to a left or right direction in respect of the vehicle 3. The vehicle 3 comprises also a power take-off 8 connected with the implement 6 for transferring a drive torque to the implement 6.

The implement 6 may be of any type as for example a plough, a seeder, a sprayer, a mower, a tedder, a rake, etc. for cultivation of the agricultural field 2. The implement 6 comprises one or more tools. The type of the tools depend on the type of the implement. In case of a seeder the tool may be designed as a seeding unit whereas in case of a sprayer the tool may be designed as a spraying nozzle. Here by way of example, as can be seen in FIG. 1 and FIG. 2, the implement 6 is designed as a rake. Such an implement is disclosed in U.S. patent application 2020/0323142 A1, entitled “Agricultural Implement”, published on Oct. 15, 2020, which is hereby incorporated by reference in its entirety.

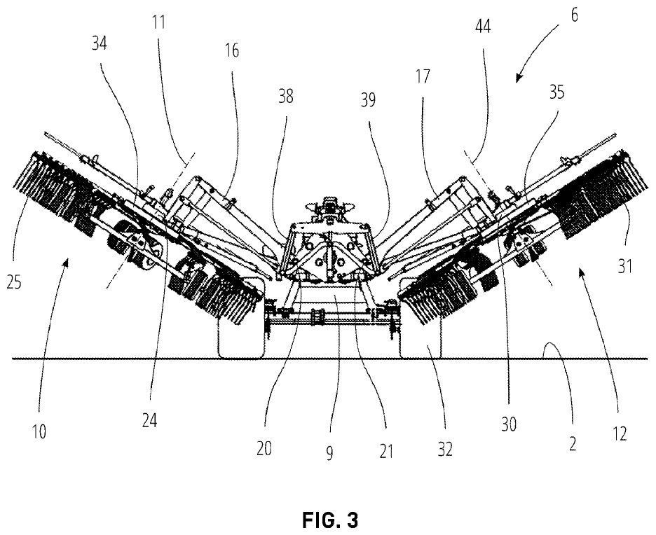

Next to the mounting linkage 7, the implement 6 comprises a chassis member 9, a wheel 32, first tool holder 16 with a first tool 10, a second tool holder 17 with a second tool 12, a third tool holder 18 with a third tool 14 and a fourth tool holder 19 with a fourth tool 15. Each of the first to fourth tools 10, 12, 14, 15 are designed as rake rotors each comprising several tines (25, 27, 29, 31). The tines 25, 27, 29, 31 of the first to fourth tools 10, 12, 14, 15 may grab crop such as grass or hay lying on the agricultural field 2 and form the crop to windrows. The first tool 10 comprises a hub 24 for a rotational connection about a rotation axis 11 with the first tool holder 16. Analogously, the second tool 12 comprises a hub 30 for a rotational connection about a rotation axis 44 with the second tool holder 17 (see FIG. 3), the third tool 14 comprises a hub 26 for a rotational connection about a rotation axis 13 with the third tool holder 18 and the fourth tool 15 comprises hub 28 for a rotational connection with the fourth tool holder 19. I. e., each of the first to fourth tools 10, 12, 14, 15 may rotate relatively to its corresponding tool holder 16, 17, 18 19. The rotational movement of each of the first to fourth tools 10, 12, 14, 15 is driven by the drive torque provided by the power take-off 8 of the vehicle 3.

The first tool holder 16 has a hinge joint 20 and is pivotably connected with the chassis members 9 of the implement 6. An actuator 38, for example a cylinder, attached between the chassis member 9 and the first tool holder 16 may drive the first tool holder 16 for pivoting about the hinge joint 20. Analogously, the second tool holder 17 is pivotably connected with the chassis member 9 for pivoting the second tool holder 17 about a hinge joint 21 by an actuator 39, the third tool holder 18 is pivotably connected with the chassis member 9 for pivoting the third tool holder 18 about a hinge joint 22 and the fourth tool holder 19 is pivotably connected with the chassis member 9 for pivoting the fourth tool holder 19 about a hinge joint 23. Hence, each of the first to fourth tools 10, 12, 14, 15 has two degrees of freedom for rotating about a corresponding rotation axis and for pivoting relatively to the chassis member 9 of the implement 6 about a corresponding hinge joint.

When the first to fourth tool holders 16, 17, 18, 19 are pivoted about their corresponding hinge joints 20, 21, 22, 23 each of the tools may be moved in an operational or out of an operational position. In the operational position of the first to fourth tools 10, 12, 14, 15 as depicted in FIG. 1 and FIG. 2, the tines of the rake rotors may be brought in engagement with the agricultural field 2 for performing a field operation as forming windrows for example. This position corresponds to an unfolded position of the first to fourth tool holders 16, 17, 18, 19. Instead, when the first to fourth tools 10, 12, 14, 15 are positioned out of the operational position as exemplarily depicted in FIG. 3 for the first and second tool 10, 12, the tines of the rake rotors may be brought out of engagement with the agricultural field 2 for avoiding a field operation by the implement 6. This position corresponds to a folded position of the corresponding tool holders since the width of the implement 6 can be reduced in comparison to the unfolded position.

A first marker 34 is assigned and fixedly attached to the first tool 10 so that the first marker 34 moves synchronously with the first tool 10 when the first tool 10 is rotated about the rotation axis 11, pivoted about the hinge joint 20 or moved due to an adjustment of the implement 6 by the coupling 5 of the vehicle 3. Analogously, a second marker 35 is assigned and attached to the second tool 12, a third marker 36 is assigned and attached to the third tool 14 and a fourth marker 37 is assigned and attached to the fourth tool 15 so that the second, third and fourth markers move synchronously with their corresponding tools, too. Hence, each of the first to fourth markers 34, 35, 36, 37 are relatively moveable in respect of another of the first to fourth markers 34, 35, 36, 37.

The height of each of the first to fourth markers 34, 35, 36, 37 is adjustable between a working and a lifting position. When one of the first to fourth tools 10, 12, 14, 15 is moved in the operational position (see FIG. 2) or out of the operational position (see FIG. 3) the height of the marker attached to the corresponding tool is adjusted from a lower position to a higher position or vice versa. When one of the first to fourth tools 10, 12, 14, 15 is in an operational position the corresponding marker attached to this tool is then in a working position representing a lower position. When one of the first to fourth tools 10, 12, 14, 15 is out of an operational position the corresponding marker attached to this tool is then in a lifting position representing a higher position.

In addition to the four markers 34, 35, 36, 37 being relatively moveable in respect of the chassis member 9, a basic marker 33 is attached to the chassis member 9 of the implement 6. Hence, the first to fourth markers 34, 35, 36, 37 are also relatively moveable in respect of the basic marker 33. The basic marker 33 moves synchronously with the chassis member 9 when the relative position of the implement 6 in respect of the vehicle 3 is adjusted by the coupling 5.

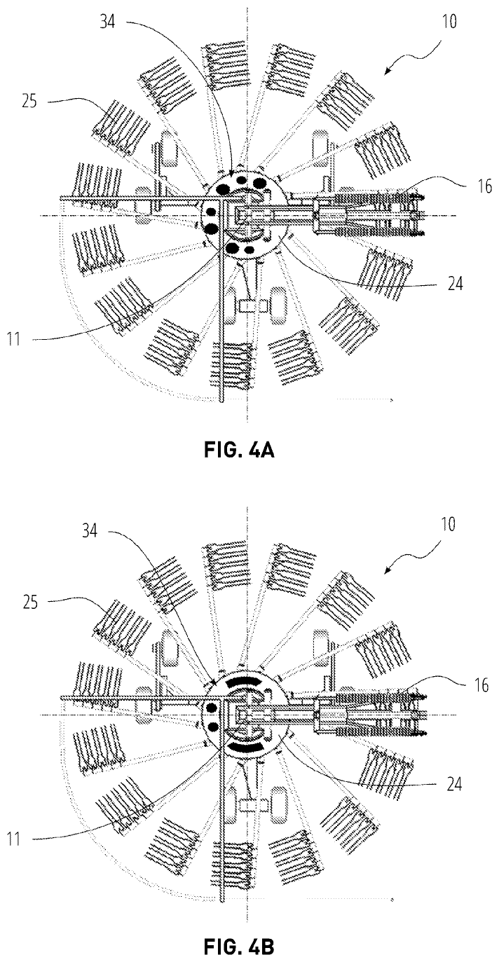

The basic marker 33 and the first to fourth markers 34, 35, 36, 37 may each comprise an optical code with a different pattern to distinguish each marker form another one. The different patterns may be QR-codes, bar codes or some kind of visible morse codes. The patterns may be designed or arranged in a circular shape. The first to fourth markers 34, 35, 36, 37 may be attached to the hubs 24, 26, 28, 30 of the first to fourth tools 10, 12, 14, 15. For example, the patters may be printed on the hubs 24, 26, 28, 30. Each marker may represent a unique identifier (ID) so that each marker can be distinguished form the another markers. FIG. 4A shows exemplarily the first tool 10 with a first type of a first marker 34 printed on the hub 24 and designed as a code with different dots. FIG. 4B shows exemplarily the first tool 10 with an alternative second type of a first marker 34 designed as a code with dots and dashes. Alternatively, the markers 33 to 37 can be designed as emitters of (electro-)magnetic waves or fields. Each emitter may emit an electromagnetic wave of a different wavelength to distinguish each marker from another one. The electromagnetic waves may be part of the visible light spectrum. FIG. 4C shows exemplarily the first tool 10 with an alternative third type of a first marker 34 comprising a first emitter 45 and a second emitter 46 attached to the hub 24. The first and second emitters 45 and 46 may be light emitting diodes (LEDs) wherein the first emitter 45 emits a light of a first wavelength and the second emitter 46 emits a light of a second wavelength being different to the first wavelength. The first to fourth markers 34, 35, 36, 37 may be all of the same type. The basic marker 33 may be of the same type as one of the first to fourth markers 34, 35, 36, 37. The markers 33 to 37 may be designed as a retrofit kit for upgrading any implement 6.

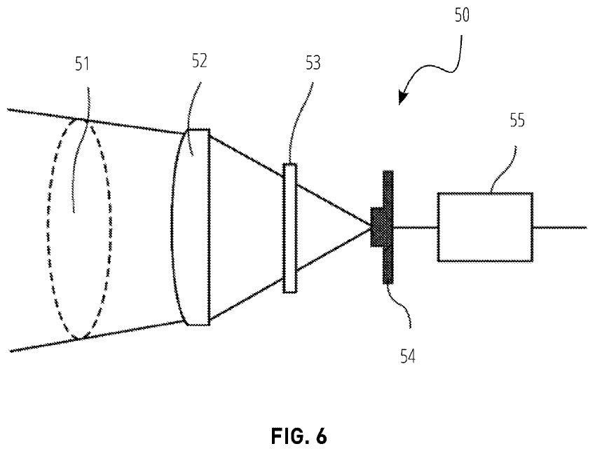

The sensor unit 4 may comprise one or more sensors and is configured to capture each of the basic and the first to fourth markers 33 to 37. For example, the sensor unit 4 may comprise a perception sensor 50 of any type such as a 2D or a 3D camera system in case of optical markers or a magnetic field sensor in case of emitters of magnetic fields. An example of a perception sensor 50 is depicted in FIG. 6. Optionally, the sensor unit 4 may comprise a LIDAR, a radar sensor or a combination of the aforementioned sensor types. The sensor unit 4 generates sensor information about the captured markers 33 to 37 and transfers the sensor information to the control unit 40. The sensor information may be send wirelessly or via a wired connection between the sensor unit 4 and the control unit 40. The sensor information may comprise spatial information of each marker 33 to 37 to determine the position of each marker in space and the distances of each marker from the sensor unit 4.

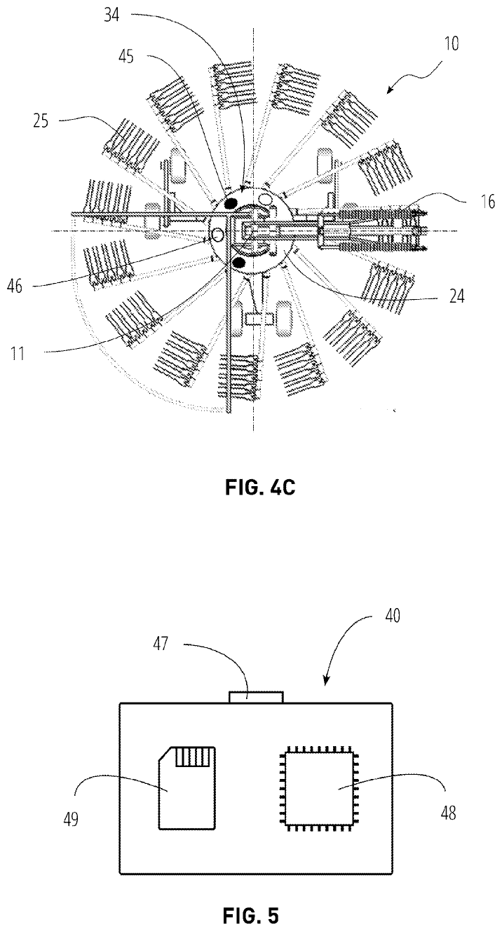

As depicted in FIG. 5, the control unit 40 comprises an interface 47, a controller 48 and a memory 49. The control unit 40 may receive and send signals or data via the interface 47. The interface 47 may be a wireless interface or a connector. The controller 48 may store the data or signals received by the control unit 40 in the memory 49. The memory 49 may contain additional data or executable computer program products, for example in terms of a computer-implemented method, that may be retrieved, processed or carried out by the controller 48. Data or signals resulting from the processing of data or signals or from the execution of a computer program product may be stored to the memory 49 or sent to the interface 47 by the controller 48.

As depicted in FIG. 6, a perception sensor 50 may also comprise at least one optical lens 52, an optional filter 53, a detector 54 and processing circuitry 55. The optical lens 52 may collect and direct light from a field of view 51 of the perception sensor 50 through the filter 53 to the detector 54 and serve to focus and/or magnify images. The at least one optical lens 52 may be of the type of a fisheye lens or any other standard and moderate wide-angle lens. A standard lens is typically defined as a lens with a focal length being approximately equal to the diagonal of the detector 54. This results in a field of view 51 that is rather similar to what human eyes see. Moderate wide-angle lenses have shorter focal lengths than standard lenses, typically ranging from 24 mm to 35 mm for full-frame cameras. These lenses offer a wider field of view 51 than standard lenses and can capture more of the scene in the frame. The optional filter 53 passes selected spectral bands such as ultraviolet, infrared or other bands. The detector 54 may be a digital image sensor that converts electromagnetic energy to an electric signal and employs image sensing technology such as charge-coupled device (CCD) technology and/or complementary metal oxide semiconductor (CMOS) technology. The processing circuitry 55 may include a circuitry for amplifying and processing the electric signal generated by the detector 54 to generate image data, which is passed to the one or more computing devices such as the control unit 40.

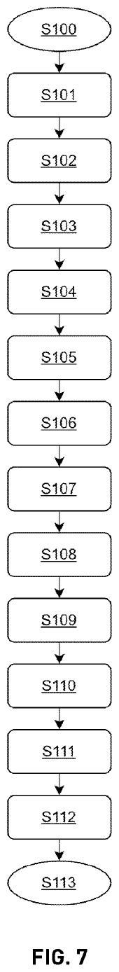

FIG. 7 shows a flow chart of a method for monitoring and controlling the implement 6 of the agricultural system 1. The method may be a computer-implemented method stored as a computer program product in the memory 49 of the control unit 40. The control unit 40 is configured to carry out the method that may be executed by the controller 48. The method is described by way of example of several steps without any restriction in respect of that steps. I. e. the number or the order of steps may be adapted, for example single steps may be excluded and/or added and executed earlier or later than described. The method starts with step S100 and proceeds to step S101.

At step S101, the control unit 40 receives the sensor information from the sensor unit 4 capturing the first marker 34 and the basic marker 33. In addition, the control unit 40 receives an absolute position of the vehicle 3 from the absolute positioning system 41.

The method proceeds to step S102 and the control unit 40 determines a relative position of the basic marker 33 in respect of the vehicle 3 based on the received sensor information. Since the absolute position of the vehicle 3 is known by the control unit 40 the control unit 40 can determine an absolute position or an absolute speed of the basic marker 33, too.

The method proceeds to step S103 and the control unit 40 processes the sensor information to determine a relative position of the first marker 34 in respect of the chassis member 9 or a relative movement of the first marker 34 in respect of the chassis member 9 or both. The position of the chassis member 9 correlates with the position of the basic marker 33 that has been already determined by the control unit 40. Thus, the control unit 40 can determine a relative position or a relative movement of the first marker 34 in respect of the basic marker 33 for determining the relative position or relative movement of the first marker 34 in respect of the chassis member 9. Optionally, the control unit 40 can determine an absolute position or an absolute speed of the first marker 34 based on the absolute position or speed of the basic marker 33.

The absolute positioning system 41, for example designed as a GNSS receiver, provides a time stamp and geo-reference for each image captured by the sensor unit 4 which is triggered by the signal from the absolute positioning system 41. The data captured by the sensor unit 4 is logged along with the pose data gathered by the absolute positioning system 41 allowing for accurate determination of the global position of the markers. An inertial measurement unit (IMU) could provide additional information about the orientation and movement of the implement 6 and the tools for improving the accuracy of the pose estimation and the reference points of the absolute positioning system 41. The implement 6 may also contain multiple sources of IMU data to track its movement and higher-order derivatives. So, the use of markers in combination with data gathered by the absolute positioning system 41 provides a cost-effective alternative to the usage of multiple RTK-GNSS units, as only a single absolute positioning system 41 (in terms of a GNSS receiver) is needed to create GNSS reference points for both the vehicle 3 and the implement 6. Such a sensor system can provide detailed information on the position, orientation and movement of the implement 6, allowing for precise control and improved efficiency in agricultural operations. Optionally, the sensor unit 4 may comprise visual odometry to estimate a relative motion of the sensor of the sensor unit 4 and the implement 6 over time which would improve accuracy of the GNSS reference points.

The control unit 40 may determine whether the first marker 34 is moving or not. The control unit 40 may also determine at least one movement parameter such as a position coordinate, a speed value or an acceleration value of the first marker 34 to quantify the relative position or the relative movement in terms of values. Accordingly, the control unit 40 determines a rotational speed of the first marker 34 rotating about its rotation axis 11. Optionally, the control unit 40 determines a pivotal speed of the first marker 34 pivoting about the hinge joint 20. The relative position of the first marker 34 in respect of the chassis member 9, the rotational speed and the pivotal speed of the first marker 34 may be determined by processing a sequence of images of the first marker 34. For example, the sensor information comprises a first image of the first marker 34 at a prior time point and a second image of the first marker 34 at a later time point. The control unit 40 may compare the two images and determine a change of the position or orientation of the first marker 34 between the two time points as well as a distance from one position to the other position. The speed of the first marker 34 may be derived from the distance and the time interval between the two time points by the control unit 40.

The relative position of the basic marker 33 in respect of the vehicle 3 may be determined in an analogous manner as the first marker 34. Steps S101 to S103 may be executed continuously to determine any positional changes of the first marker 34 and the basic marker 33 as well as any derivatives of the positional changes such as speed.

The method proceeds to step S104 and the control unit 40 determines a target position for the first marker 34 and a target speed value for the first marker 34. The target position may deviate from the current position of the first marker 34 as well as the target speed value may deviate from the current rotational speed of the first marker 34.

The target position may be any position between the working position and the lifting position of the first marker 34 so that the first marker 34 can be positioned to the target position by pivoting the first tool holder 16. The target position may be any angular position in respect of the rotation axis 11 so that the first marker 34 can be positioned to the target position by rotating the first marker 34 accordingly. Furthermore, the target position may be any position the first marker 34 can be positioned to by adjusting the coupling 5 for moving the chassis member 9 of the implement 6. The target speed value may be any speed value between zero and a maximum value the first marker 34 can be rotated with about the rotation axis 11 or pivoted with about the hinge joint 20 or adjusted with by the coupling 5.

The method proceeds to step S105 and the control unit 40 compares the current position of the first marker 34 with the target position to determine a deviation of the current position of the first marker 34 from the target position.

The method proceeds to step S106 and the control unit 40 controls the implement 6 to reduce the positional deviation between the first marker 34 and the target position. The control unit 40 determines which part of the implement 6 needs to be adjusted to reduce the deviation. The deviation may be reduced by rotating the first tool 10 about the rotation axis 11, by pivoting the first tool holder 16 about the hinge joint 20 or by adjusting the coupling 5. Then, the control unit 40 moves the first marker 34 to the target position accordingly. For example, the control unit 40 may control the power take-off 8 to rotate the first marker 34 to the target position or may control the actuator 38 to move the first marker 34 relatively to the chassis member 9 to the target position or may adjust the coupling 5 to move the first marker 34 to the target position.

The method proceeds to step S107 and the control unit 40 compares the current speed of the first marker 34 with the target speed value to determine a deviation of the rotational speed of the first marker 34 from the target speed value.

The method proceeds to step S108 and the control unit 40 controls the implement 6 to reduce the deviation between the speed of the first marker 34 and the target speed value. The control unit 40 determines which part of the implement 6 needs to be adjusted to reduce the deviation. The deviation may be reduced by adjusting the rotational speed of the first tool 10 about the rotation axis 11, by adjusting the pivotal speed of the first tool holder 16 about the hinge joint 20 or by adjusting the speed of the coupling 5. Then, the control unit 40 adjusts the speed of the first marker 34 to the target speed value accordingly. For example, the control unit 40 may adjust the rotational speed of the power take-off 8 or adjust the actuating speed of the actuator 38 or adjust the speed 3-point hitch for adjusting the speed of the first marker 34 to the target speed value and for reducing the deviation.

The control unit 40 receives continuously the sensor information from the sensor unit 4 and processes the sensor information to check if the target position or the target speed value has been reached by the first marker 34. But the deviation may not be reduced in case of a failure. For example, the rotational speed of the first marker 34 may remain below the target speed value although the control unit 40 sends commands to speed up the rotational speed of the first marker 34. Then, the control unit 40 recognizes that a failure may be present such as a blockage of the first tool 10 due to an obstacle or too much load of the crop and executes a safety function. In such a case, the method optionally proceeds to step S109 and the control unit 40 moves the first marker 34 out of the working position if the rotational speed of the first marker 34 is below the target speed value and the deviation between the speed of the first marker 34 and the target speed value can't be reduced. Then, the first tool 10 will be brought out of contact with the obstacle or the crop causing too much load so that the first marker 34 may rotate freely again and may speed up to the target speed value.

The method proceeds to step S110 for checking the consistency between the power take-off 8 and the first marker 34. Since the first tool 10 is driven by the power take-off 8 there is a direct dependency between the revolutions of the power take-off 8 and the revolutions of the first marker 34. The control unit 40 may determine a rotational movement parameter of the power take-off 8 such as an angle or a rotational speed. The control unit 40 may also determine a movement parameter of the first marker 34 such as a movement distance, an angle or a speed. Then, the control unit 40 may compare the movement parameter of the power take-off 8 with the movement parameter of the first marker 34 as for example the rotational speed of the power take-off 8 with the rotational speed of the first marker 34 and check whether both movement parameters are consistent. For this example, both movement parameters would be consistent if the rotational speed of the first marker 34 correlates with the rotational speed of the power take-off 8 under consideration of the gear ratio between the first tool 10 and the power take-off 8. Otherwise, both movement parameters would be inconsistent what could be an indication of a failure in the drive torque transfer from the power take-off 8 to the first tool 10. Then, the control unit 40 could send a warning message to the operator of the agricultural system 1.

The method proceeds to step S111 and the control unit 40 determines a quality indicator of the first tool 10. The quality indicator is a parameter to evaluate the work result of the tools, here the first tool 10. The quality indicator of a tool may be low if the work result of the tool is poor and may be higher if the work result of the tool is better. The quality indicator may be determined based on a work result of the first tool 10 after the field operation. The work result of the first tool 10 after the field operation may be determined based on images comprising a status of a field area of the agricultural field 2 after the field operation. The images may be captured by at least one camera which may be part of the sensor unit 4. Optionally, the control unit 40 determines not only a status of a field area 43 of the agricultural field 2 after the field operation but also a status of a field area 42 of the agricultural field 2 before the field operation. Then, the control unit 40 may determine the quality indicator of the first tool 10 based on a comparison of the status of the field area 42 ahead of the first tool 10 and the status of the field area 43 behind of the first tool 10 (see FIG. 2). For example, the first tool 10 in terms of a rake rotor will form hay lying in a field area 42 ahead of the first tool 10 to a windrow that can be detected in the field area 43 behind the first tool 10. The shape of the windrow may be part of the images captured by the at least one camera and may be evaluated by the control unit 40.

The method proceeds to step S112 and the control unit 40 determines a target quality indicator that may be predefined and stored in the memory 49 of the control unit 40. The control unit 40 compares the quality indicator of the first tool 10 with the target quality indicator to determine whether the work results of the first tool 10 are of a sufficient quality. For example, the quality indicator of the first tool 10 may be below the target quality indicator so that the control unit 40 determines a deviation of a quality indicator of the operation of the first tool 10 from a target quality indicator. Then, the control unit 40 adjusts a movement parameter of the first marker 34 for reducing the deviation of the quality indicator from the target quality indicator. For example, the rotary speed of the first tool 10 may be too slowly to form windrows of sufficient quality. As consequence, the control unit 40 speeds up the rotational speed of the first marker 34 for improving the quality and reducing the deviation between the quality indicator and the target quality indicator.

Finally, the method ends with step S113. Optionally, the method may be restarted again.

The method was explained by way of example of the first marker 34 and the first tool 10. Analogously to the first marker 34 and the first tool 10, the method may be applied to and executed for each of the second, third or fourth markers 35, 36, 37 and the second, third and fourth tools 10, 12, 14, 15, too.

All references cited herein are incorporated herein in their entireties. If there is a conflict between definitions herein and in an incorporated reference, the definition herein shall control.

### LISTING OF DRAWING ELEMENTS

1 agricultural system
2 agricultural field
3 vehicle
4 sensor unit
5 coupling
6 implement
7 mounting linkage
8 power take-off
9 chassis member
10 first tool
11 rotation axis
12 second tool
13 rotation axis
14 third tool
15 fourth tool
16 first tool holder
17 second tool holder
18 third tool holder
19 fourth tool holder
20 hinge joint
21 hinge joint
22 hinge joint
23 hinge joint
24 hub
25 tine
26 hub
27 tine
28 hub
29 tine
30 hub
31 tine
32 wheel
33 basic marker
34 first marker
35 second marker
36 third marker
37 fourth marker
38 actuator
39 actuator
40 control unit
41 absolute positioning system
42 field area
43 field area
44 rotation axis
45 emitter
46 emitter
47 interface
48 controller
49 memory
50 perception sensor
51 field of view
52 lens
53 filter
54 detector
55 processing circuitry

1. An agricultural system, comprising:
an implement with
a chassis member;
a first tool relatively moveable in respect of the chassis member; and
a first marker assigned to the first tool;
a sensor unit configured to capture the first marker; and
a control unit configured
to receive sensor information from the sensor unit; and
to determine a relative position or a relative movement of the first marker in respect of the chassis member.

2. The agricultural system of claim 1, wherein
the sensor unit comprises a perception sensor comprising a fish-eye lens.

3. The agricultural system of claim 1, wherein
the control unit is configured to determine both a relative position and a relative movement of the first marker in respect of the chassis member.

4. The agricultural system of any one of claim 1, comprising
a vehicle with a coupling for connecting the implement with the vehicle.

5. The agricultural system of claim 4, wherein the implement comprises
a basic marker assigned to the chassis member; wherein
the sensor unit is configured to capture the basic marker; and wherein
the control unit is configured to determine a relative position of the basic marker in respect of the vehicle.

6. The agricultural system of claim 5, wherein the first marker is relatively moveable in respect of the basic marker.

7. The agricultural system of claim 1, wherein
the first marker is fixed to the first tool.

8. The agricultural system of claim 1, wherein
the first marker is an optical code.

9. The agricultural system of claim 1, wherein
the first tool is rotatable about a rotation axis.

10. The agricultural system of claim 9, wherein
the control unit is configured to determine a rotational speed of the first marker.

11. The agricultural system of claim 9, wherein
the control unit is configured to determine a deviation of the rotational speed of the first marker from a target speed value.

12. The agricultural system of claim 6, the vehicle comprising a power take-off for driving the first tool; wherein
the control unit is configured
to determine a rotational movement parameter of the power take-off;
to determine a movement parameter of the first marker; and
to check whether the movement parameter of the first marker and the rotational movement parameter of the power take-off are consistent.

13. The agricultural system of claim 1,
wherein
the control unit is configured
to determine a deviation of a quality indicator of the operation of the first tool from a target quality indicator; and
to adjust a movement parameter of the first marker for reducing the deviation of the quality indicator from the target quality indicator.

14. The agricultural system of claim 13, wherein
the control unit is configured
to determine a status of a field area ahead of the first tool and a status of a field area behind the first tool; and
to determine the quality indicator of the operation of the first tool based on a comparison of the status of the field area ahead of the first tool and the status of the field area behind of the first tool.

15. The agricultural system of claim 6, wherein
the coupling is adjustable for adjusting the position of the first marker in respect of the vehicle; and
the control unit is configured
to determine a target position for the first marker; and
to adjust the coupling for moving the first marker to the target position.

16. The agricultural system of claim 1, wherein
the control unit is configured
to determine a target position for the first marker; and
to move the first tool relatively to the chassis member for moving the first marker to the target position.

17. The agricultural system of claim 16, wherein
the first tool is moveably attached to a first tool holder;
the first tool holder is moveably attached to the chassis member of the implement for adjusting a height of the first marker between a lifting position and a working position for bringing the first tool in or out of an operational position.

18. The agricultural system of claim 17, wherein
the first tool holder is pivotable about a hinge joint.

19.-21 (canceled)

22. A method for monitoring and controlling an implement of an agricultural system comprising:
receiving sensor information of a first marker being relatively movable in respect of a chassis member of the implement;
determining a relative speed of the first marker in respect of the chassis member;
determining a target speed value for the first marker;
determining a deviation of the relative speed of the first marker from the target speed value; and
reducing the deviation of the relative speed of the first marker from the target speed value by adjusting the relative speed of the first marker.
